(19) United States
(12) Patent Application Publication
(10) Pub. No.: US 2016/0356707 A1
(43) Pub. Date: Dec. 8, 2016

(54) MEASUREMENT METHOD, MEASUREMENT APPARATUS, AND MANUFACTURING METHOD FOR OPTICAL ELEMENT

(71) Applicant: CANON KABUSHIKI KAISHA, Tokyo (JP)

(72) Inventor: Tomohiro Sugimoto, Yoshikawa-shi (JP)

(21) Appl. No.: 15/163,065

(22) Filed: May 24, 2016

(30) Foreign Application Priority Data
Jun. 2, 2015 (JP) 2015-112504

(51) Int. Cl. G01N 21/41

(52) U.S. Cl. CPC G01N 21/4133

(57) ABSTRACT

A test object is placed inside a medium, and wavefronts of light transmitted through the test object are measured at a plurality of wavelengths. From the transmitted wavefronts of the test object measured at the plurality of wavelengths and transmitted wavefronts at a plurality of wavelengths when a reference object having a specific group refractive index distribution is placed in the medium, a changing rate of a wavefront aberration with respect to wavelength corresponding to a difference between the transmitted wavefront of the test object and the transmitted wavefront of the reference object is calculated. A refractive index distribution of the test object is calculated on the basis of the changing rate of the wavefront aberration with respect to wavelength.

### BACKGROUND OF THE INVENTION

### Field of the Invention

The present invention relates to a method and apparatus for measuring a refractive index distribution of an optical element, and to a process for manufacturing such an optical element.

### Description of the Related Art

A lens manufacturing method using mold forming causes a refractive index distribution inside a lens. The refractive index distribution inside the mold-formed lens may cause adverse affects in the optical performance of a lens. For this reason, manufacturing of a mold-formed lens requires a technique of nondestructively measuring the refractive index distribution of the lens after mold-forming.

U.S. Pat. No. 5,151,752, for example, proposes a method for calculating a refractive index distribution of a test object by immersing the test object in two kinds of phase refractive-index matching liquids and measuring interference fringes by using coherent light. U.S. Pat. No. 8,472,014 proposes a method for measuring a transmitted wavefront of a test object by using two kinds of lights having different wavelengths and calculating a refractive index distribution by using the transmitted wavefront and a transmitted wavefront of a reference object having a specific phase refractive index distribution.

In the method disclosed in U.S. Pat. No. 5,151,752, since the transmittance of matching oil having a high phase refractive index is low, only small signals are obtained in measurement of a transmitted wavefront of the test object having a high phase refractive index, and this lowers measurement accuracy.

The method disclosed in U.S. Pat. No. 8,472,014 assumes that the phase refractive index of the reference object is known. The phase refractive index of the reference object needs to coincide with the phase refractive index at one point (for example, the center of a lens) inside the test object. For this reason, the measurement method for the refractive index distribution disclosed in U.S. Pat. No. 8,472,014 requires a technique of nondestructively measuring the phase refractive index at one point inside the test object. However, it is difficult to nondestructively measure the phase refractive index. Although low-coherence interferometry and wave scanning interferometry can nondestructively measure the refractive index, the refractive index to be measured is not the phase refractive index, but is the group refractive index. Further, the phase refractive index converted from the group refractive index includes a conversion error.

### SUMMARY OF THE INVENTION

The various aspects of the present invention provide a measurement method and a measurement apparatus that can nondestructively measure a refractive index distribution of a test object with high accuracy, and a manufacturing method for an optical element.

A measurement method, according to an aspect of the present invention, includes a measurement step of placing a test object in a medium and measuring wavefronts of light of a plurality of wavelengths transmitted through the test object, and a calculation step of calculating, from the transmitted wavefronts of the test object measured at the plurality of wavelengths and from wavefronts of light of the plurality of wavelengths transmitted through a reference object having a specific group refractive index distribution placed in the medium, a changing rate of a wavefront aberration corresponding to a difference between the transmitted wavefront of the test object and the transmitted wavefront of the reference object with respect to wavelength and calculating a refractive index distribution of the test object based on the changing rate of the wavefront aberration with respect to wavelength.

A manufacturing method for an optical element, according to another aspect of the present invention, includes a step of forming an optical element by mold forming, and a step of evaluating the formed optical element by measuring a refractive index distribution of the optical element. The refractive index distribution of the optical element is measured by a measurement method including a measurement step of placing a test object in a medium and measuring wavefronts of light of a plurality of wavelengths transmitted through the test object, and a calculation step of calculating, from the transmitted wavefronts of the test object measured at the plurality of wavelengths and transmitted wavefronts at the plurality of wavelengths when a reference object having a specific group refractive index distribution is placed in the medium, a changing rate of a wavefront aberration corresponding to a difference between the transmitted wavefront of the test object and the transmitted wavefront of the reference object with respect to wavelength and calculating a refractive index distribution of the test object based on the changing rate of the wavefront aberration with respect to wavelength.

A measurement apparatus, according to a further aspect of the present invention, includes a light source, a wavefront sensor configured to measure transmitted wavefronts of a test object at a plurality of wavelengths by using light from the light source, and a computer configured to calculate, from the transmitted wavefronts of the test object measured at the plurality of wavelengths and transmitted wavefronts at the plurality of wavelengths when a reference object having a specific group refractive index distribution is placed in a medium, a changing rate of a wavefront aberration corresponding to a difference between the transmitted wavefront of the test object and the transmitted wavefront of the reference object with respect to wavelength and to calculate a refractive index distribution of the test object based on the changing rate of the wavefront aberration with respect to wavelength.

A method of measuring refractive index distribution, according to a still further aspect of the present invention, includes measuring wavefronts of light of a plurality of wavelengths transmitted through a test object immersed in a liquid medium, calculating, from the transmitted wavefronts of the test object measured at the plurality of wavelengths and from wavefronts of light of the plurality of wavelengths transmitted through a reference object having a specific group refractive index distribution immersed in the liquid medium, a rate of a change of wavefront aberration corresponding to a difference between the transmitted wavefront of the test object and the transmitted wavefront of the reference object, and calculating a refractive index distribution of the test object based on the calculated rate of change of wavefront aberration.

Further features of the present invention will become apparent from the following description of exemplary embodiments with reference to the attached drawings.

### BRIEF DESCRIPTION OF THE DRAWINGS

FIG. 1 is a block diagram of a measurement apparatus, according to a first embodiment.

FIG. 2 is a flowchart showing a procedure for calculating the refractive index distribution of a test object, according to the first embodiment.

FIGS. 3A and 3B illustrate a coordinate system defined on a test object and the optical path of a light beam inside the measurement apparatus, respectively, according to the first embodiment.

FIG. 4 is a block diagram of a measurement apparatus, according to a second embodiment.

FIG. 5 shows a procedure for manufacturing an optical element.

### DESCRIPTION OF THE EMBODIMENTS

Embodiments of the present invention will be described below with reference to the attached drawings.

### First Embodiment

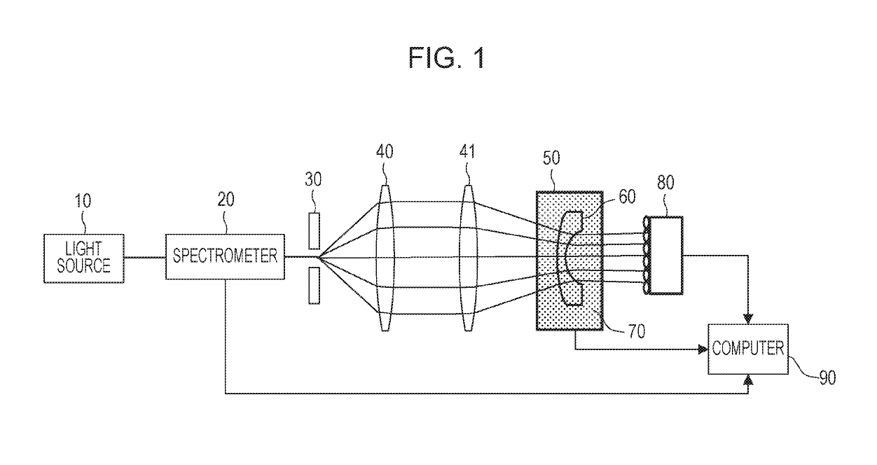

FIG. 1 is a block diagram of a measurement apparatus according to a first embodiment of the present invention. The measurement apparatus includes a light source 10, an illumination optical system, a container 50 that can store a test object 60 and a medium 70, a wavefront sensor 60, and a computer 90. The measurement apparatus is configured to (made to) measure the refractive index distribution of the test object 60. The illumination optical system includes a pinhole 30 and collimator lenses 40 and 41. In the first embodiment, a Shack-Hartmann sensor is used as the wavefront sensor 80. While the test object 60 in the first embodiment is a lens having negative power, it may be a lens having positive power or may be a flat plate.

In the first embodiment, the light source 10 is a light source that emits light having a plurality of wavelengths (for example, a supercontinuum light source). The light having the plural wavelengths passes through a spectrometer or monochromator 20 and is converted into quasi-monochromatic light. The quasi-monochromatic light passes through the pinhole 30 and is converted into divergent wave. The divergent wave passes through the collimator lenses 40 and 41, is converted into convergent light, and enters the container 50. After passing through the medium 70 and the test object 60 in the container 50, the convergent light is converted into nearly parallel light, and is detected by the wavefront sensor 80.

Side surfaces of the container 50 are formed of a material that transmits light (for example, glass). The medium 70 in the container 50 is liquid such as oil. The medium 70 is not limited to liquid, and may be gas or a solid. When the medium 70 is air, the container 50 may be omitted.

The refractive index of the medium 70 is calculated by a medium refractive-index calculator (not illustrated.). For example, the medium refractive-index calculator is composed of a thermometer that measures the temperature of the medium and a computer that converts the measured temperature into the refractive index of the medium. More specifically, the computer can include a memory that stores refractive indices of the medium 70 as a function of wavelength and temperature. This allows the computer to calculate, on the basis of the temperature of the medium 70 measured by the temperature sensor, the refractive index of the medium 70 at the measured temperature according to each of the wavelengths. When the temperature change of the medium 70 is small, a lookup table showing data on refractive indices with respect to wavelength and temperature may be used. Alternatively, the medium refractive-index calculator may include a wavefront sensor that measures the transmitted wavefront of a glass prism having known refractive index and shape and immersed in the medium, and a computer that calculates the refractive index of the medium from the transmitted wavefront and the shape. The medium refractive-index calculator may measure the phase refractive index or may measure the group refractive index.

The refractive index is classified into a phase refractive index n(λ) relating to a phase velocity v(λ) serving as a moving velocity of an equiphase surface of light and a group refractive index n_{g}(λ) relating to a moving velocity (moving velocity of a wave packet) v_{g}(λ) of light energy. The phase refractive index and the group refractive index are correlated by Expression 2 described later.

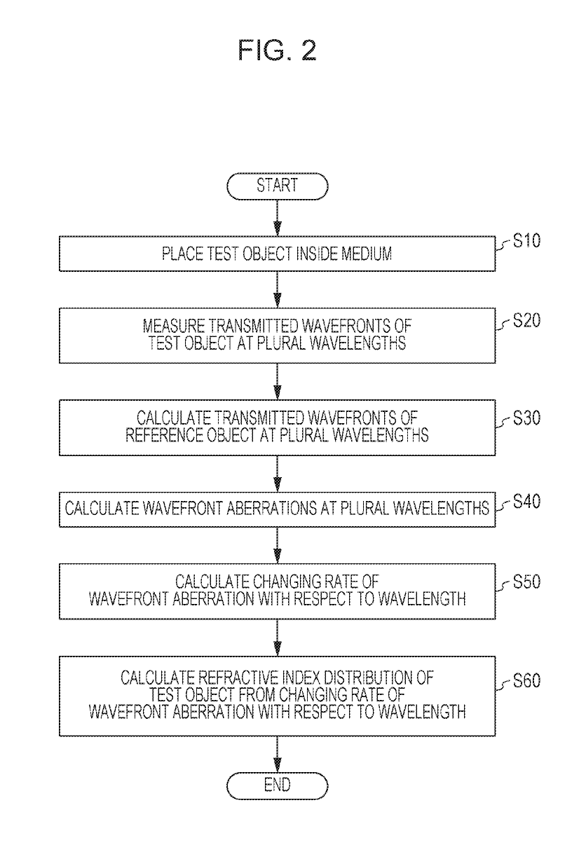

The computer 90 functions as a calculating device that calculates the refractive index distribution of the test object 60 using the measurement result of the wavefront sensor 80 and the refractive index of the medium 70. The computer 90 also functions as a control device (controller) that controls the wavelength of light passing through the monochromator 20. The computer 90 is formed by, for example, a CPU which executes programmed processes (algorithms), such as those illustrated in FIG. 2.

FIG. 2 is a flowchart showing a calculation procedure for calculating the refractive index distribution of the test object 60. In FIG. 2, “S” is an abbreviation of Step.

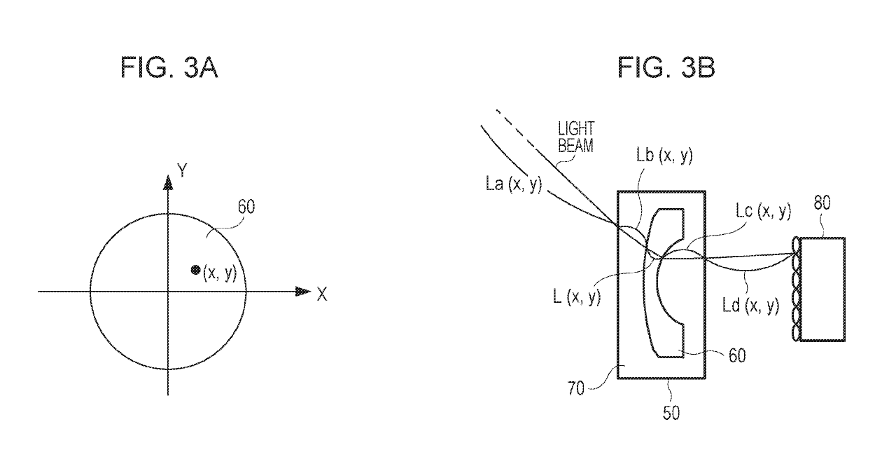

First, the test object 60 is placed inside the medium 70 (S10). Next, the wavefronts of light transmitted through the test object 60 are measured at a plurality of wavelengths while changing the wavelength of the light with the monochromator 20 (S20). A transmitted wavefront Wₘ(λ) of the to object 60 at a point (x, y) inside the test object 60 illustrated in FIG. 3A is expressed by Expression 1:

$${W}_{m} ( λ ) = \frac{2 π}{λ} [ {L}_{a} ( x , y ) + {n}^{medium} ( λ ) {L}_{b} ( x , y ) + n ( λ , x , y ) L ( x , y ) + {n}^{medium} ( λ ) {L}_{c} ( x , y ) + {L}_{d} ( x , y ) ] \qquad ( 1 )$$

where Lₐ(x,y), L_{b}(x,y), L_{c}(x,y), and L_{d}(x,y) represent the geometric distances between the elements along a light beam illustrated in FIG. 3B. The light beam in FIG. 3B shows a light beam passing through the point (x,y) inside the test object 60 illustrated in FIG. 3A. L(x,y) represents the geometric distance of the optical path of the light beam inside the test object 60, that is, the thickness of the test object 60 in the light direction. Further, n^{medium}(λ) represents the phase refractive index of the medium 70 at the wavelength λ, and n(λ,x,y) represents the phase refractive index of the test object 60 at the wavelength λ. Herein, the thickness of the side surfaces of the container 50 is ignored for simplicity.

Then, transmitted wavefronts of a reference object having a specific group refractive index distribution are calculated at a plurality of wavelengths (S30). In this step (S30), a reference object having the same shape as that of the test object 60 and a uniform group refractive index distribution is assumed (reference object), and transmitted wavefronts of the reference object at the same wavelengths as that of S20 are calculated in a state in which the reference object is disposed at the same position as that of the test object 60 in measurement of the transmitted wavefronts Wₘ(λ) in S20.

The group refractive index of the reference object needs to coincide with the group refractive index n_{g}(λ,x,y) of the test object 60 at the specific point (x,y). The group refractive index n_{g}(λ,x,y) at the specific point (x, y) corresponds to a group refractive index obtained by averaging group refractive indices in the test object in the light direction of FIG. 3B. The group refractive index n_{g}(λ,x,y) at the specific point (x, y) needs to be measured by another measurement method (for example, a refractive-index measurement method using low-coherence interferometry or wavelength scanning interferometry). The point (x, y) where the group refractive index is measured may be an arbitrary point. Measurement of a group refractive index n_{g}(λ,0,0) at a point (0,0) (that is, measurement of a group refractive index on the optical axis) is relatively easy. In the first embodiment, it is assumed that the reference object has a uniform group refractive index n_{g}(λ,0,0) at the wavelength λ.

Calculation of the transmitted wavefront Wₛᵢₘ(λ) of the reference object does not require the group refractive index n_{g}(λ,0,0), but requires the phase refractive index n(λ,0,0). The phase refractive index n(λ,0,0) needs to be obtained from the group refractive index n_{g}(λ,0,0) on the basis of the relationship of Expression 2:

$${n}_{g} ( λ , 0 , 0 ) = n ( λ , 0 , 0 ) - λ \frac{d n ( λ , 0 , 0 )}{d λ} \\ n ( λ , 0 , 0 ) = C λ - λ {\int }_{{λ}_{0}}^{λ} \frac{{n}_{g} ( λ , 0 , 0 )}{{λ}^{2}} d λ \qquad ( 2 )$$

where C represents the integration constant, and λ₀ represents an arbitrary wavelength constant. Although there is one way of converting the phase refractive index into the group refractive index, there are limitless ways of converting the group refractive index into the phase refractive index under the influence of the integration constant C. Accordingly, for example, the phase refractive index of the reference object can be calculated by using a phase refractive index N(λ) of a base material of the test object according to Expression 3:

$$n ( λ , 0 , 0 ) + Δ n ( λ ) = {n}_{g} ( λ , 0 , 0 ) + λ \frac{d N ( λ )}{d λ} \\ ( Δ n ( λ ) = λ \frac{d Δ n ( λ )}{d λ} = λ [ \frac{d N ( λ )}{d λ} - \frac{d n ( λ , 0 , 0 )}{d λ} ] ) . \qquad ( 3 )$$

Since the phase refractive index n(λ,0,0) of the test object is different from the phase refractive index N(λ) of the base material, the phase refractive index obtained by Expression. 3 includes an error Δn(λ). In the present invention, however, the value of the group refractve index n_{g}(λ,0,0) is important, and the phase refractve index may include an error. The method of converting the group refractive index into the phase refractive index is not limited to Expression 3, and may be other conversion methods. However, it is necessary that the value of a group refractive index inversely converted from the converted phase refractive index again should coincide with the measurement value n_{g}(λ,0,0) of the group refractive index. When the medium refractive-index calculator calculates the group refractive index n_{g}^{medium}(λ) of the medium 70, the group refractive index n_{g}^{medium}(λ) similarly needs to be converted into the phase refractive index n^{medium}(λ).

Transmitted wavefronts of the reference object are calculated at a plurality of wavelengths by using the phase refractive index obtained by Expression 3. A transmitted wavefront Wₛᵢₘ(λ) is expressed by Expression 4:

$${W}_{sim} ( λ ) = \frac{2 π}{λ} \{ {L}_{a} ( x , y ) + {n}^{medium} ( λ ) {L}_{b} ( x , y ) + [ n ( λ , 0 , 0 ) + Δ n ( λ ) ] ( L ( x , y ) + {n}^{medium} ( λ ) {L}_{c} ( x , y ) + {L}_{d} ( x , y ) \} . \qquad ( 4 )$$

Then, wavefront aberrations corresponding to differences between the transmitted wavefronts of the test object and the transmitted wavefronts of the reference object are calculated (S40). The wavefront aberration W(λ) is expressed by Expression 5:

$$W ( λ ) = {W}_{m} ( λ ) - {W}_{sim} ( λ ) = \frac{2 π}{λ} [ n ( λ , x , y ) - n ( λ , 0 , 0 ) - Δ n ( λ ) ] L ( x , y ) . \qquad ( 5 )$$

If the phase refractive index n(λ,0,0) is measured with high accuracy (that is, Δn(λ)=0), a refractive index distribution n(λ,x,y)-n(λ,0,0) of the test object 60 is calculated by dividing the wavefront aberration W(λ) of Expression 5 by 2π/λ and the thickness L(x,y). However, it is difficult to nondestructively measure the phase refractive index n(λ,0,0) of the test object with high accuracy. The method of directly calculating the refractive index distribution n(λ,x,y)-n(λ,0,0) from Expression 5 does not have high accuracy because it includes a refractive index distribution error Δn(λ)/L(x,y) originating from a phase refractive-index measurement error Δn(λ).

Next, the changing rate of the wavefront aberration with respect to wavelength is calculated (S50). A changing rate dW(λ)/dλ of the wavefront aberration W(λ) with respect to wavelength is expressed by Expression 6 using Expressions 2 and 3:

$$\frac{d W ( λ )}{d λ} = - \frac{2 π}{{λ}^{2}} [ {n}_{g} ( λ , x , y ) - {n}_{g} ( λ , 0 , 0 ) ] L ( x , y ) . \qquad ( 6 )$$

Finally, a refractive index distribution of the test object is calculated from the changing rate of the wavefront aberration with respect to wavelength (S60). The refractive index distribution of the test object is expressed by Expression 8 using an approximation of

$$\begin{matrix}Expression 7 \text{:} & \\ \frac{d n ( λ , x , y )}{d λ} \sim \frac{d n ( λ , 0 , 0 )}{d λ} & ( 7 ) \\ n ( λ , x , y ) - n ( λ , 0 , 0 ) = {n}_{g} ( λ , x , y ) - {n}_{g} ( λ , 0 , 0 ) = - \frac{{λ}^{2}}{2 π} \frac{d W ( λ )}{d λ} \frac{1}{L ( x , y )} . & ( 8 )\end{matrix}$$

The changing rate of the wavefront aberration with respect to wavelength is a function of the group refractive index. Since analysis using the changing rate of the wavefront aberration with respect to wavelength directly uses the group refractive index n_{g}(λ,0,0) that can be nondestructively measured, it does not include an error originating from the phase refractive index measurement error Δn(λ). For this reason, the measurement method for the refractive index distribution according to the present invention can nondestructively measure the refractive index distribution of the test object with high accuracy.

In general, the dispersion distribution of the refractive index is unlikely to occur in a lens manufactured by molding forming. Hence, an approximation of Expression 7 is established. In contrast, an approximation of Expression 7 is not established in a lens in which the dispersion distribution is purposely caused to reduce chromatic aberration. It is necessary to pay attention in measurement of the dispersion distribution lens according to the present invention because the error is included.

In the first embodiment, it is assumed that the test object 60 and the reference object have the same shape. If the shape or the test object 60 and the shape or the reference object are different, the obtained refractive index distribution includes error. For this reason, the shape of the test object 60 measured beforehand can be applied to the shape of the reference object. Alternatively, the designed value can be applied as the shape of the reference object if the shape error from the designed value of the test object 60 is removed. A shape error ΔL(x,y) can be removed, for example, by the following method.

When the test object has a shape error ΔL(x,y) from the designed value, the transmitted wavefront Wₘ(λ) of the test object is expressed by Expression 9. The wavefront aberration W(λ) and the changing rate dW(λ)/dλ of the wavefront aberration with respect to wavelength are expressed by Expression 11 using an approximation of Expression 10:

$$\begin{matrix}{W}_{m} ( λ ) = \frac{2 π}{λ} \{ {L}_{a} ( x , y ) + {n}^{medium} ( λ ) {L}_{b} ( x , y ) + n ( λ , x , y ) [ L ( x , y ) + Δ L ( x , y ) ] + {n}^{medium} ( λ ) [ {L}_{c} ( x , y ) - Δ L ( x , y ) ] + {L}_{d} ( x , y ) \} & ( 9 ) \\ [ n ( λ , x , y ) - n ( λ , 0 , 0 ) ] Δ L ( x , y ) \sim 0 & ( 10 ) \\ W ( λ ) = \frac{2 π}{λ} \{ [ n ( λ , x , y ) - n ( λ , 0 , 0 ) - n ( λ ) ] L ( x , y ) + [ n ( λ , 0 , 0 ) - {n}^{medium} ( λ ) ] Δ L ( x , y ) \} \\ \frac{d W ( λ )}{d λ} = - \frac{2 π}{{λ}^{2}} \{ [ {n}_{g} ( λ , x , y ) - {n}_{g} ( λ , 0 , 0 ) ] L ( x , y ) + [ {n}_{g} ( λ , 0 , 0 ) - {n}_{g}^{medium} ( λ ) ] Δ L ( x , y ) \} . & ( 11 )\end{matrix}$$

In general, the wavelength dependency of the refractive index of the test object 60 is different from the wavelength dependency of the refractive index of the medium 70. For this reason, the shape error (shape component) ΔL(x,y) can be removed from a simultaneous equation of a changing rate dW(λ₁)/dλ of the wavefront aberration with respect to wavelength at a wavelength λ₁ and a changing rate dW(λ₂)/dλ of the wavefront aberration with respect to wavelength at a wavelength λ₂. A refractive index distribution at the wavelength λ₁ and a refractive index distribution at the wavelength λ₂ are related to each other by Expression 13 using an approximation expression of Expression 12. The refractive index distribution at the wavelength λ₁ is calculated according to Expression 14 by using dW(λ₁)/dλ, dW(λ₂)/dλ, Expression 7, and Expression 13:

$$\begin{matrix}\frac{{n}_{g} ( {λ}_{1} , x , y ) - {n}_{g} ( {λ}_{2} , x , y )}{{n}_{g} ( {λ}_{2} , x , y ) - 1} \sim \frac{{n}_{g} ( {λ}_{1} , 0 , 0 ) - {n}_{g} ( {λ}_{2} , 0 , 0 )}{{n}_{g} ( {λ}_{2} , 0 , 0 ) - 1} & ( 12 ) \\ {n}_{g} ( {λ}_{2} , x , y ) - {n}_{g} ( {λ}_{2} , 0 , 0 ) = \frac{{n}_{g} ( {λ}_{2} , 0 , 0 ) - 1}{{n}_{g} ( {λ}_{1} , 0 , 0 ) - 1} [ {n}_{g} ( {λ}_{1} , x , y ) - {n}_{g} ( {λ}_{1} , 0 , 0 ) ] & ( 13 ) \\ n ( {λ}_{1} , x , y ) - n ( {λ}_{1} , 0 , 0 ) = \frac{\begin{matrix}[ {n}_{g} ( {λ}_{1} , 0 , 0 ) - {n}_{g}^{medium} ( {λ}_{1} ) ] {λ}_{2}^{2} \frac{d W ( {λ}_{2} )}{d λ} - \\ [ {n}_{g} ( {λ}_{2} , 0 , 0 ) - {n}_{g}^{medium} ( {λ}_{2} ) ] {λ}_{1}^{2} \frac{d W ( {λ}_{1} )}{d λ}\end{matrix}}{\begin{matrix}\frac{{n}_{g} ( {λ}_{2} , 0 , 0 ) - 1}{{n}_{g} ( {λ}_{1} , 0 , 0 ) - 1} [ {n}_{g} ( {λ}_{1} , 0 , 0 ) - {n}_{g}^{medium} ( {λ}_{1} ) ] - \\ [ {n}_{g} ( {λ}_{2} , 0 , 0 ) - {n}_{g}^{medium} ( {λ}_{2} ) ]\end{matrix}} \frac{- 1}{2 π L ( x , y )} . & ( 14 )\end{matrix}$$

When the difference between the wavelength λ₁ and the wavelength λ₂ is small, since the denominator of Expression 14 is small, accuracy of the obtained refractive index distribution is low. To increase the accuracy of the refractive index distribution obtained by Expression 14, it is necessary to enlarge the difference between the wavelength λ₁ and the wavelength λ₂. For example, red light (620 to 750 nm) is selected as light of the wavelength λ₁ and blue light (450 to 500 nm) is selected as light of the wavelength λ₂. Since it is only necessary to enlarge the wavelength difference, ultraviolet or infrared light may be selected.

In the first embodiment, after the wavefront aberration W(λ) corresponding to the difference between the transmitted wavefront Wm(λ) of the test object and the transmitted wavefront Wsim(λ) of the reference object is calculated, the changing rate dW(λ)/dλ of the wavefront aberration with respect to wavelength is calculated. Alternatively, after the changing rate dWm(λ)/dλ of the transmitted wavefront of the test object with respect to wavelength and the changing rate dWsim(λ)/dλ of the transmitted wavefront of the reference object with respect to wavefront are calculated, the changing rate dW(λ)/dλ of the wavefront aberration with respect to wavelength, which corresponds to the difference between the above changing rates, may be calculated.

In the first embodiment, the wavelength is scanned by the combination of the light source for emitting light having a plurality of wavelengths and the monochromator. In the first embodiment, a supercontinuum light source is used as the light source for emitting light having a plurality of wavelengths. Alternatively, a superluminescent diode (SLD), a short-pulse laser, or a halogen lamp can be used as the light source for emitting light having a plurality of wavelengths. Instead of the combination of the light source for emitting light having a plurality of wavelengths and the monochromator, a wavelength-swept light source may be used, or a multiline laser for discretely emitting light having a plurality of wavelengths may be used. The light source is not limited to the single light source, and may be a combination of a plurality of light sources. Since it is only necessary in the present invention to measure the changing rate of the wavefront aberration with respect to wavelength, a light source for emitting light having two or more kinds of wavelengths can be sufficient.

In the first embodiment, a Shack-Hartmann sensor is used as the wavefront sensor 80. It is only necessary that the wavefront sensor 80 can measure the transmitted wavefront having a large aberration. Alternatively, the wavefront sensor 80 can be substituted with a wavefront sensor using a Hartmann method or a wavefront sensor using shearing interferometry such as a Talbot interferometer.

The optical path length distribution (=refractive index distribution×L(x,y)) can be substituted with the refractive index distribution as the physical quantity showing the optical performance of the mold lens. Therefore, the measurement method (measurement apparatus) for the refractive, index distribution according to the present invention also refers to a measurement method (measurement apparatus) for the optical path length distribution.

### Second Embodiment

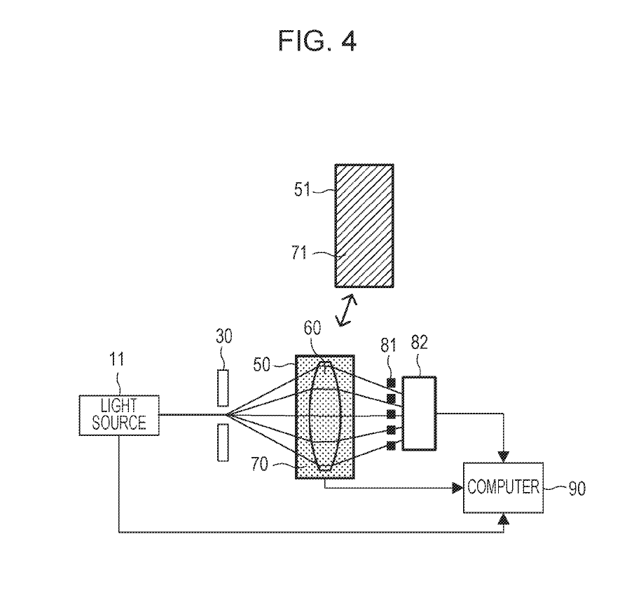

FIG. 4 is a block diagram of a measurement apparatus according to a second embodiment. In the second embodiment, a light source 11 is a multiline gas laser that discretely emits light at a plurality of wavelengths (for example, an argon laser or a krypton laser). In the second embodiment, a Talbot interferometer composed of a two-dimensional diffraction grating 81 and a two-dimensional sensor 82, such as a CCD or a CMOS, is used as a wavefront sensor. A test object is a lens having positive power. In the second embodiment, a test object having shape error is immersed in two kinds of media, the shape error is removed by using transmitted wavefronts of the media, and a refractive index distribution is calculated. In the first embodiment, the wavefront is defined as the product of the wave number and the optical path length distribution (=(2π/λ)×refractive index distribution×L(x,y)). In contrast, in the second embodiment, the wavefront is defined as the optical path length distribution (=refractive index distribution×L(x,y)). An illumination optical system in the second embodiment includes only a pinhole 30. Structures similar to those adopted in the first embodiment are described with the same signs.

Light emitted from the light source 11 passes through the pinhole 30, is converted into divergent light, and then enters a container that stores a test object 60 and a medium. The light entering the container passes through the medium and the test object 60, and is then converted into convergent light. The convergent light is measured by the Talbot interferometer composed of the diffraction grating 81 and the two-dimensional sensor 82. The wavelength of light emitted by the light source 11 is controlled by a computer 90 which can be configured to (programmed to) function as a wavelength controlling device. A container 50 that stores a first medium 70 (for example, water) and a container 51 that stores a second medium 71 (for example, oil) can be exchanged. The refractive index of the first medium 70 (first refractive index) is different from the refractive index of the second medium 71 (second refractive index.).

First, the test object 60 is placed inside the first medium 70. Next, first transmitted wavefronts Wₘ₁(λ) and Wₘ₁(λ+Δλ) of the test object 60 are measured at two kinds of wavelengths (a plurality of wavelengths) λ and λ+Δλ. The first transmitted wavefronts of the test object 60 at the plural wavelengths are expressed by Expression 15:

$${W}_{m 1} ( λ ) = {L}_{a 1} ( x , y ) + {n}_{1}^{medium} ( λ ) {L}_{b 1} ( x , y ) + n ( λ , x , y ) [ {L}_{1} ( x , y ) + Δ L ( x , y ) ] + {n}_{1}^{medium} ( λ ) [ {L}_{c 1} ( x , y ) - Δ L ( x , y ) ] + {L}_{d 1} ( x , y ) \\ {W}_{m 1} ( λ + Δ λ ) = {L}_{a 1} ( x , y ) + {n}_{1}^{medium} ( λ + Δ λ ) {L}_{b 1} ( x , y ) + n ( λ + Δ λ , x , y ) [ {L}_{1} ( x , y ) + Δ L ( x , y ) ] + {n}_{1}^{medium} ( λ + Δ λ ) [ {L}_{c 1} ( x , y ) - Δ L ( x , y ) ] + {L}_{d 1} ( x , y ) \qquad ( 15 )$$

where Lₐ₁(x,y), t_{b1}(x,y), t_{c1}(x,y), and tₐ₁(x,y) represent geometric distances between the elements in the first medium 70 along the light beam illustrated in FIG. 3B, L₁(x,y) represents the thickness of the test object 60 in the light direction inside the test object 60 in the first medium 70, and n₁^{medium}(λ) represents the phase refractive index of the first medium 70 at the wavelength λ. Since the wavefront is defined as the optical path length distribution in the second embodiment, the wavefront of the second embodiment does not include 2π/λ in Expression 1.

Next, transmitted wavefronts Wₛᵢₘ₁(λ) and Wₛᵢₘ₁(λ+Δλ) of a reference object in the first medium 70 are calculated. Then, first wavefront aberrations W₁(λ) and W₁(λ+Δλ) in the first medium 70 are calculated. The transmitted wavefronts of the reference object in the first medium 70 are expressed by Expression 16. The first wavefront aberrations are expressed by Expression 17 using an approximation of Expression 10:

$$\begin{matrix}{W}_{sim 1} ( λ ) = {L}_{a 1} ( x , y ) + {n}_{1}^{medium} ( λ ) {L}_{b 1} ( x , y ) + [ n ( λ , 0 , 0 ) + Δ n ( λ ) ] {L}_{1} ( x , y ) + {n}_{1}^{medium} ( λ ) {L}_{c 1} ( x , y ) + {L}_{d 1} ( x , y ) & ( 16 ) \\ {W}_{sim 1} ( λ + Δ λ ) = {L}_{a 1} ( x , y ) + {n}_{1}^{medium} ( λ + Δ λ ) {L}_{b 1} ( x , y ) + [ n ( λ + Δ λ , 0 , 0 ) + Δ n ( λ + Δ λ ) ] {L}_{1} ( x , y ) + {n}_{1}^{medium} ( λ + Δ λ ) {L}_{c 1} ( x , y ) + {L}_{d 1} ( x , y ) & \\ \begin{matrix}{W}_{1} ( λ ) = {W}_{m 1} ( λ ) - {W}_{sim 1} ( λ ) \\ = [ n ( λ , x , y ) - n ( λ , 0 , 0 ) - Δ n ( λ ) ] {L}_{1} ( x , y ) + \\ [ n ( λ , 0 , 0 ) - {n}_{1}^{medium} ( λ ) ] Δ L ( x , y )\end{matrix} \\ \begin{matrix}{W}_{1} ( λ + Δ λ ) = {W}_{m 1} ( λ + Δ λ ) - {W}_{sim 1} ( λ + Δ λ ) \\ = [ n ( λ + Δ λ , x , y ) - n ( λ + Δ λ , 0 , 0 ) - Δ n ( λ + Δ λ ) ] \\ {L}_{1} ( x , y ) + [ n ( λ + Δ λ , 0 , 0 ) - {n}_{1}^{medium} ( λ + Δ λ ) ] Δ L ( x , y ) .\end{matrix} & ( 17 )\end{matrix}$$

A changing rate ΔW₁(λ)/Δλ of the first wavefront aberration with respect to wavelength is calculated, and W_{g1}(λ) serving as the function of a group refractive index is calculated according to Expression 18. Further, n_{g1}^{medium}(λ) represents the group refractive index of the first medium 70 at the wavelength λ.

$$\begin{matrix}{W}_{g 1} ( λ ) = {W}_{1} ( λ ) - λ \frac{Δ {W}_{1} ( λ )}{Δλ} \\ = {W}_{1} ( λ ) - λ \frac{{W}_{1} ( λ + Δ λ ) - {W}_{1} ( λ )}{Δλ} = [ {n}_{g} ( λ , x , y ) - {n}_{g} ( λ , 0 , 0 ) ] \\ {L}_{1} ( x , y ) + [ {n}_{g} ( λ , 0 , 0 ) - {n}_{g 1}^{medium} ( λ ) ] Δ L ( x , y ) .\end{matrix} \qquad ( 18 )$$

Next, the container that stores the test object 60 is exchanged from the container 50 containing the first medium 70 to the container 51 containing the second medium 71, and the test object 60 is placed inside the second medium 71. Next, second transmitted wavefronts Wₘ₂(λ) and Wₘ₂(λ+Δλ) of the test object 60 at two kinds of wavelengths λ and λ+Δλ are measured. Then, transmitted wavefronts Wₛᵢₘ₂(λ) and Wₛᵢₘ₂(λ+Δλ) of the reference object in the second medium 71 are calculated. Then, second wavefront aberrations W₂(λ) and W₂(λ+Δλ) in the second medium 71 are calculated. A changing rate ΔW₂(λ)/Δλ of the second wavefront aberration with respect to wavelength is calculated, and W_{g2}(λ) serving as the function of the group refractive index is calculated according to Expression 19:

$$\begin{matrix}{W}_{g 2} ( λ ) = {W}_{2} ( λ ) - λ \frac{Δ {W}_{2} ( λ )}{Δλ} \\ = {W}_{2} ( λ ) - λ \frac{{W}_{2} ( λ + Δ λ ) - {W}_{2} ( λ )}{Δλ} \\ = [ {n}_{g} ( λ , x , y ) - {n}_{g} ( λ , 0 , 0 ) ] \\ {L}_{2} ( x , y ) + [ {n}_{g} ( λ , 0 , 0 ) - {n}_{g 2}^{medium} ( λ ) ] Δ L ( x , y )\end{matrix} \qquad ( 19 )$$

where L₂(x,y) represents the thickness of the test object 60 in the light direction inside the test object 60 in the second medium 71, and ⁿ_{g2}^{medium}(λ) represents the group refractive index of the second medium 71 at the wavelength λ. Since the first refractive index and the second refractive index are different, the optical path inside the test object 60 in the first medium and the optical path inside the test object 60 in the second medium are also different. That is, L₁(x,y) and L₂(x,y) are different from each other. In contrast, since the difference between the shape error in the first medium and the shape error in the second medium due to the optical path is small enough to ignore, the same shape error ΔL(x,y) is used in the first and second media of the second embodiment.

Finally, the shape error (error component) is removed from W_{g1}(λ) calculated from the changing rate of the wavefront aberration in the first medium with respect to wavelength and W_{g2}(λ) calculated from the changing rate of the wavefront aberration in the second medium with respect to wavelength, so that a refractive index distribution is calculated according to Expression 20. Calculation of Expression 20 also uses Expression 7.

$$n ( λ , x , y ) - n ( λ , 0 , 0 ) = \frac{\begin{matrix}[ {n}_{g} ( λ , 0 , 0 ) - {n}_{g 1}^{medium} ( λ ) ] {W}_{g 2} ( λ ) - \\ [ {n}_{g} ( λ , 0 , 0 ) - {n}_{g 2}^{medium} ( λ ) ] {W}_{g 1} ( λ )\end{matrix}}{\begin{matrix}[ {n}_{g} ( λ , 0 , 0 ) - {n}_{g 1}^{medium} ( λ ) ] - \\ [ {n}_{g} ( λ , 0 , 0 ) - {n}_{g 2}^{medium} ( λ ) ]\end{matrix}} \frac{1}{{L}_{eff} ( x , y )} \\ {L}_{eff} ( x , y ) = \frac{\begin{matrix}[ {n}_{g} ( λ , 0 , 0 ) - {n}_{g 1}^{medium} ( λ ) ] {L}_{2} ( x , y ) - \\ [ {n}_{g} ( λ , 0 , 0 ) - {n}_{g 2}^{medium} ( λ ) ] {L}_{1} ( x , y )\end{matrix}}{[ {n}_{g} ( λ , 0 , 0 ) - {n}_{g 1}^{medium} ( λ ) ] - [ {n}_{g} ( λ , 0 , 0 ) - {n}_{g 2}^{medium} ( λ ) ]} \qquad ( 20 )$$

where L_{eff}(x,y) represents the effective thickness of the test object obtained from the thickness L₁(x,y) of the test object in the first medium and the thickness L₂(x,y) of the test object in the second medium. When L₁(x,y) and L₂(x,y) are equal, L_{eff}(x,y) is equal to L₁(x,y) and L₂(x,y).

In the second embodiment, the first medium and the second medium are exchanged together with the container. Alternatively, only the media may be exchanged while the container is fixed. When the first medium is air and the second medium is water, the media are exchanged only by injecting water into the container. Instead of exchanging the media, the change in refractive index due to the temperature change of the medium may be used. In this manner, by simply changing the temperature of the first medium, a second medium having a second refractive index different from the first refractive index is created.

In the second embodiment, the function W_{g}(λ) of the group refractive index at the wavelength λ is calculated from the changing rate of the wavefront aberration with respect to wavelength. Instead of the value at the wavelength λ, a value W_{g}(λ+Δλ/2) at an average wavelength. λ+Δλ/2 of the wavelength λ and the wavelength λ+Δλ may be calculated. The value W_{g}(λ+Δλ/2) is calculated according to Expression 21. Here, indices 1 and 2 showing the first medium and the second medium are omitted.

$${W}_{g} ( λ + \frac{Δ λ}{2} ) = \frac{W ( λ ) + W ( λ + Δλ )}{2} - ( λ + \frac{Δ λ}{2} ) \frac{W ( λ + Δλ ) + W ( λ )}{Δ λ} \qquad ( 21 )$$

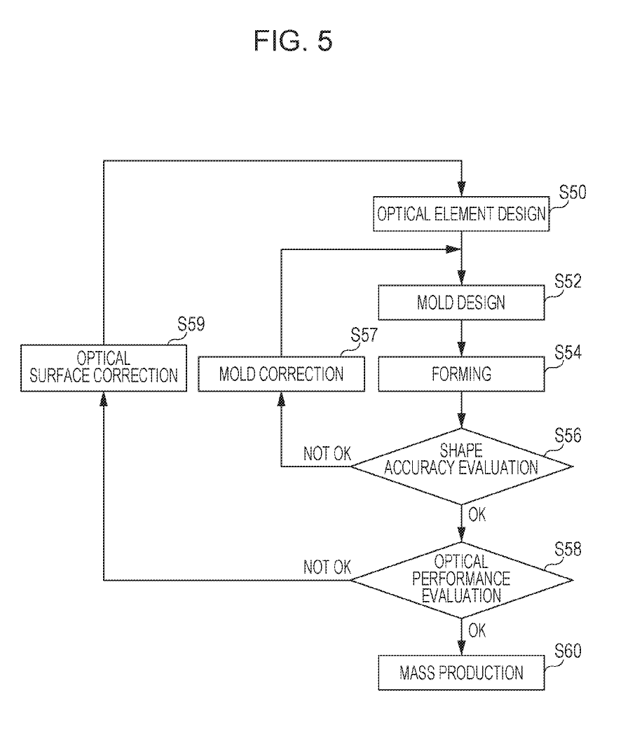

FIG. 5 shows a manufacturing procedure for an optical element using mold forming. An optical element is manufactured through a process for designing the optical element (S50), a process for designing a mold (S52), and a mold forming process of forming the optical element using the mold (S54). The process of forming the optical element using the mold may include injection molding, for example. The shape accuracy of the formed optical element is evaluated (S56). When the accuracy is insufficient (S56: NOT OK), the mold parameters are corrected (S57), and mold design (S52) and optical element forming (S54) are performed again iteratively. When the shape accuracy is sufficient (S56: OK), optical performance of the optical element is evaluated (S58). The measurement apparatus of the present invention can be used in the evaluation process of the optical performance at S58. When the evaluated optical performance does not satisfy the required specifications (S58: NOT OK), the correction amount of an optical surface of the optical element is calculated (S59), and the optical element is designed again (S50) on the basis of the calculation result. When the optical performance satisfies the required specifications (S58: OK), the optical element is put into mass production (S60).

Since the refractive index distribution of the optical element is measured with high accuracy by the manufacturing method for the optical element according to this embodiment, mass production of optical elements can be accurately performed by using mold forming.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application. No. 2015-112504, filed Jun. 2, 2015, which is hereby incorporated by reference herein in its entirety.

What is claimed is:

1. A measurement method comprising:
a measurement step of placing a test object in a medium and measuring wavefronts of light of a plurality of wavelengths transmitted through the test object; and
a calculation step of calculating, from the transmitted wavefronts of the test object measured at the plurality of wavelengths and from wavefronts of light of the plurality of wavelengths transmitted through a reference object having a specific group refractive index distribution placed in the medium, a changing rate of wavefront aberration corresponding to a difference between the transmitted wavefront of the test object and the transmitted wavefront of the reference object with respect to wavelength and calculating a refractive index distribution of the test object based on the changing rate of the wavefront aberration with respect to wavelength.

2. The measurement method according to claim 1, wherein the refractive index distribution of the test object is calculated by removing a shape component of the test object based on the changing rates of the wavefront aberrations with respect to wavelength at a plurality of wavelengths.

3. The measurement method according to claim 1,
wherein, in the measurement step, first transmitted wavefronts in a first medium having a first refractive index and second transmitted wavefronts in a second medium having a second refractive index different from the first refractive index are measured at the plurality of wavelengths, and
wherein, in the calculation step, first wavefront aberrations corresponding to differences between measurement results of the first transmitted wavefronts and transmitted wavefronts when the reference object is placed in the first medium is calculated at the plurality of wavelengths, second wavefront aberrations corresponding to differences between measurement results of the second transmitted wavefronts and transmitted wavefronts when the reference object is placed in the second medium is calculated at the plurality of wavelengths, a changing rate of the first wavefront aberration with respect to wavelength is calculated from the first wavefront aberrations calculated at the plurality of wavelengths, a changing rate of the second wavefront aberration with respect to wavelength is calculated from the second wavefront aberrations calculated at the plurality of wavelengths, and the refractive index distribution of the test object is calculated by removing a shape component of the test object based on the changing rate of the first wavefront aberration with respect to wavelength and the changing rate of the second wavefront aberration with respect to wavelength.

4. A manufacturing method for an optical element, comprising:
a step of forming the optical element by mold forming; and
a step of evaluating the formed optical element by measuring a refractive index distribution of the optical element,
wherein the refractive index distribution of the optical element is measured by a measurement method including
a measurement step of placing a test object in a medium and measuring wavefronts of light of a plurality of wavelengths transmitted through the test object, and
a calculation step of calculating, from the transmitted wavefronts of the test object measured at the plurality of wavelengths and transmitted wavefronts at the plurality of wavelengths when a reference object having a specific group refractive index distribution is placed in the medium, a changing rate of a wavefront aberration corresponding to a difference between the transmitted wavefront of the test object and the transmitted wavefront of the reference object with respect to wavelength and calculating a refractive index distribution of the test object based on the changing rate of the wavefront aberration with respect to wavelength.

5. A measurement apparatus comprising:
a light source;
a wavefront sensor configured to measure transmitted wavefronts of a test object at a plurality of wavelengths by using light from the light source; and
a computer configured to calculate, from the transmitted wavefronts of the test object measured at the plurality of wavelengths and transmitted wavefronts at the plurality of wavelengths when a reference object having a specific group refractive index distribution is placed in a medium, a changing rate of a wavefront aberration corresponding to a difference between the transmitted wavefront of the test object and the transmitted wavefront of the reference object with respect to wavelength and to calculate a refractive index distribution of the test object based on the changing rate of the wavefront aberration with respect to wavelength.

6. The measurement apparatus according to claim 5, wherein the computer calculates the refractive index distribution of the test object by removing a shape component of the test object based on the changing rates of the wavefront aberrations with respect to wavelength at a plurality of wavelengths.

7. The measurement apparatus according to claim 5,
wherein the wavefront sensor measures first transmitted wavefronts in a first medium having a first refractive index and second transmitted wavefronts in a second medium having a second refractive index different from the first refractive index at a plurality of wavelengths, and
wherein the computer calculates, at the plurality of wavelengths, first wavefront aberrations corresponding to differences between measurement results of the first transmitted wavefronts and transmitted wavefronts when the reference object is placed in the first medium, calculates, at the plurality of wavelengths, second wavefront aberrations corresponding to differences between measurement results of the second transmitted wavefronts and transmitted wavefronts when the reference object is placed in the second medium, calculates a changing rate of the first wavefront aberration with respect to wavelength from the first wavefront aberrations calculated at the plurality of wavelengths, calculates a changing rate of the second wavefront aberration with respect to wavelength from the second wavefront aberrations calculated at the plurality of wavelengths, and calculates the refractive index distribution of the test object by removing a shape component of the test object based on the changing rate of the first wavefront aberration with respect to wavelength and the changing rate of the second wavefront aberration with respect to wavelength.

8. A method of measuring refractive index distribution, comprising:
measuring wavefronts of light of a plurality of wavelengths transmitted through a test object immersed in a liquid medium;
calculating, from the transmitted wavefronts of the test object measured at the plurality of wavelengths and from wavefronts of light of the plurality of wavelengths transmitted through a reference object having a specific group refractive index distribution immersed in the liquid medium, a rate of change of wavefront aberration corresponding to a difference between the transmitted wavefront of the test object and the transmitted wavefront of the reference object; and
calculating a refractive index distribution of the test object based on the calculated rate of change of wavefront aberration.
